(19) United States
(12) Patent Application Publication
(10) Pub. No.: US 2025/0385379 A1
(43) Pub. Date: Dec. 18, 2025

(54) BATTERY PACK

(71) Applicant: HONDA MOTOR CO., LTD., Tokyo (JP)

(72) Inventor: Keisuke YOMOGIZAWA, Tokyo (JP)

(73) Assignee: HONDA MOTOR CO., LTD., Tokyo (JP)

(21) Appl. No.: 19/231,607

(22) Filed: Jun. 9, 2025

(30) Foreign Application Priority Data
Jun. 14, 2024 (JP) 2024-096390

(51) Int. Cl. H01M 50/298; H01M 50/209; H01M 50/249; H01M 50/505; H01M 50/522

(52) U.S. Cl. CPC H01M 50/298; H01M 50/209; H01M 50/249; H01M 50/505; H01M 50/522; H01M 2220/20

(57) ABSTRACT

A battery pack includes: plural electrical devices including a cell stack in which plural battery cells are stacked and a junction board electrically connected to the cell stack; and a case that accommodates the plural electrical devices, the plural electrical devices include a first electrical device and a second electrical device that are respectively disposed at one end and another end of the case in a predetermined first direction among horizontal directions and are electrically connected to each other via a bus bar, and plural third electrical devices disposed between the first electrical device and the second electrical device in the first direction, and the bus bar extends in a space between adjacent ones of the plural third electrical devices or a space between the plural third electrical devices and the case, to connect the first electrical device and the second electrical device.

### CROSS-REFERENCE TO RELATED APPLICATION

This application is based on and claims priority under 35 USC 119 from Japanese Patent Application No. 2024-096390 filed on Jun. 14, 2024.

### TECHNICAL FIELD

The present invention relates to a battery pack.

### BACKGROUND ART

In recent years, researches and developments have been conducted on a secondary battery which contributes to improvement in energy efficiency in order to allow more people to have access to affordable, reliable, sustainable and advanced energy.

For example, Patent Literature 1 discloses a vehicle drive battery unit mounted on an electric vehicle or the like. The battery unit includes a plurality of battery modules, a first electrical connection box, a second electrical connection box, and a battery unit case that accommodates these components. The first electrical connection box and the second electrical connection box are electrically connected by a center cable including a high voltage electric power line.
Patent Literature 1: JP2022-040956A

### SUMMARY OF INVENTION

In Patent Literature 1, although a space inside the battery unit case is effectively used by routing the center cable in a space above a bus bar connecting the battery modules, there is still room for improvement in terms of space saving.

The present invention provides a battery pack that can achieve space saving.

The present invention provides
a battery pack including:
a plurality of electrical devices including a cell stack in which a plurality of battery cells are stacked and a junction board electrically connected to the cell stack; and
a case that accommodates the plurality of electrical devices, in which
the plurality of electrical devices include
   a first electrical device and a second electrical device that are respectively disposed at one end and another end of the case in a predetermined first direction among horizontal directions and are electrically connected to each other via a bus bar, and
   a plurality of third electrical devices disposed between the first electrical device and the second electrical device in the first direction, and
the bus bar extends in a space between the third electrical devices adjacent to each other or a space between the third electrical devices and the case, and connects the first electrical device and the second electrical device.

According to the present invention, since the first electrical device and the second electrical device respectively disposed at the one end and the other end of the case are electrically connected to each other using the bus bar, it is possible to achieve space saving as compared to using a cable for connection. In addition, since the space between the adjacent third electrical devices or the space between the third electrical devices and the case is used for extending the bus bar, space saving can be further achieved.

### BRIEF DESCRIPTION OF DRAWINGS

FIG. 1 is a perspective view of a battery pack 20 according to an embodiment of the present invention.

FIG. 2 is a perspective view of the battery pack 20 in a state in which an upper cover 50 is removed.

FIG. 3 is a top view of the battery pack 20 in the state in which the upper cover 50 is removed.

FIG. 4 is a schematic view showing wiring between a first junction board 31 disposed on a front side and a second junction board 32 disposed on a rear side.

FIG. 5 is a schematic view showing wiring between a plurality of battery modules 21 and the second junction board 32 (dash-dot line).

FIG. 6 is a perspective view of bus bars 71 and 72.

FIG. 7 is a perspective view of the bus bars 71 and 72 routed along a rib 44 provided in a lower case 40.

### DESCRIPTION OF EMBODIMENTS

Hereinafter, an embodiment of a battery pack of the present invention will be described with reference to the accompanying drawings. The drawings are viewed in directions of reference numerals. In addition, in the present specification and the like, for the sake of simplicity and clarity of explanation, a front-rear direction, a left-right direction, and an upper-lower direction are described according to directions viewed from a driver of a vehicle on which the battery pack is mounted, and in the drawings, a front side of the vehicle is represented by Fr, a rear side is represented by Rr, a left side is represented by L, a right side is represented by R, an upper side is represented by U, and a lower side is represented by D.

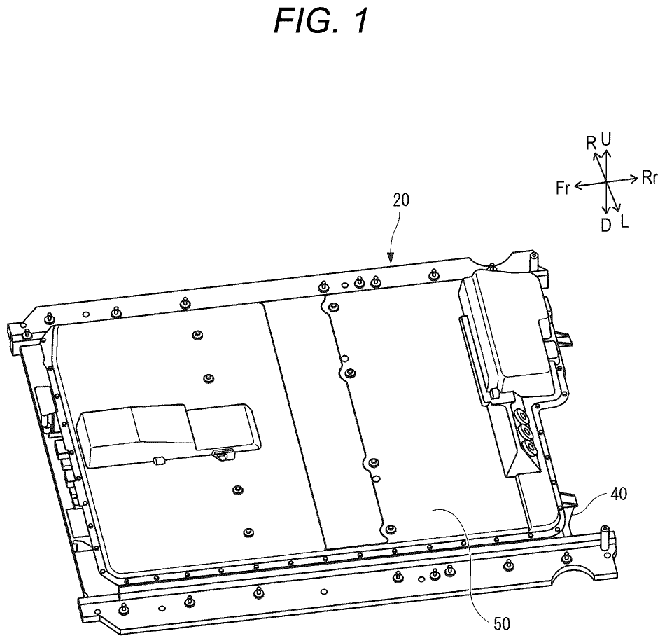

A battery pack 20 shown in FIGS. 1 to 3 is mounted under a floor of the vehicle such as an electric automobile. The battery pack 20 includes a lower case 40 whose upper portion is opened and an upper cover 50 that covers the upper portion of the lower case 40. An internal space 60 surrounded by the lower case 40 and the upper cover 50 is formed in the battery pack 20.

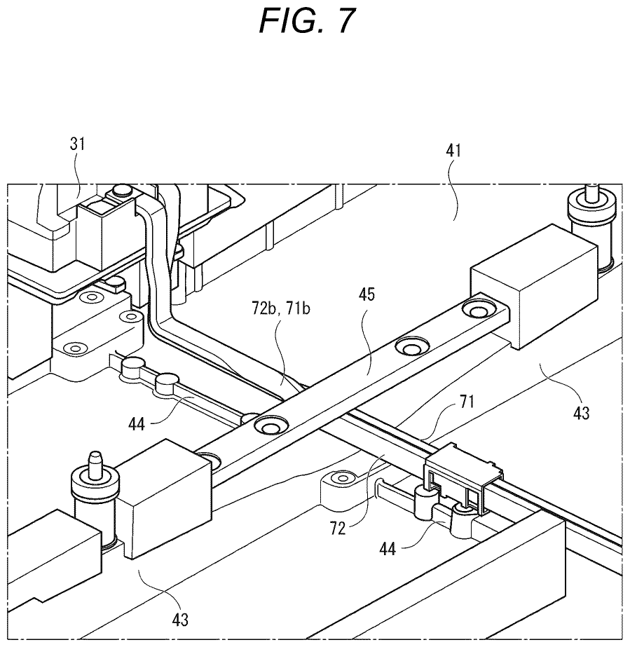

The lower case 40 includes a bottom plate portion 41 that covers lower portions of a plurality of battery modules 21, left and right side wall portions 42 that stand upward and extend in the front-rear direction at both left and right ends of the bottom plate portion 41, and a plurality of cross members 43 that stand upward and extend in the left-right direction at an intermediate portion of the bottom plate portion 41. In addition, as shown in FIG. 7, the lower case 40 includes a rib 44 that stands upward and extends in the front-rear direction at a central portion of the bottom plate portion 41 in the left-right direction. A reinforcing plate 45 is appropriately provided at each upper portion of a part of the cross members 43. The reinforcing plate 45 is, for example, a plate-shaped member made of high-tensile steel.

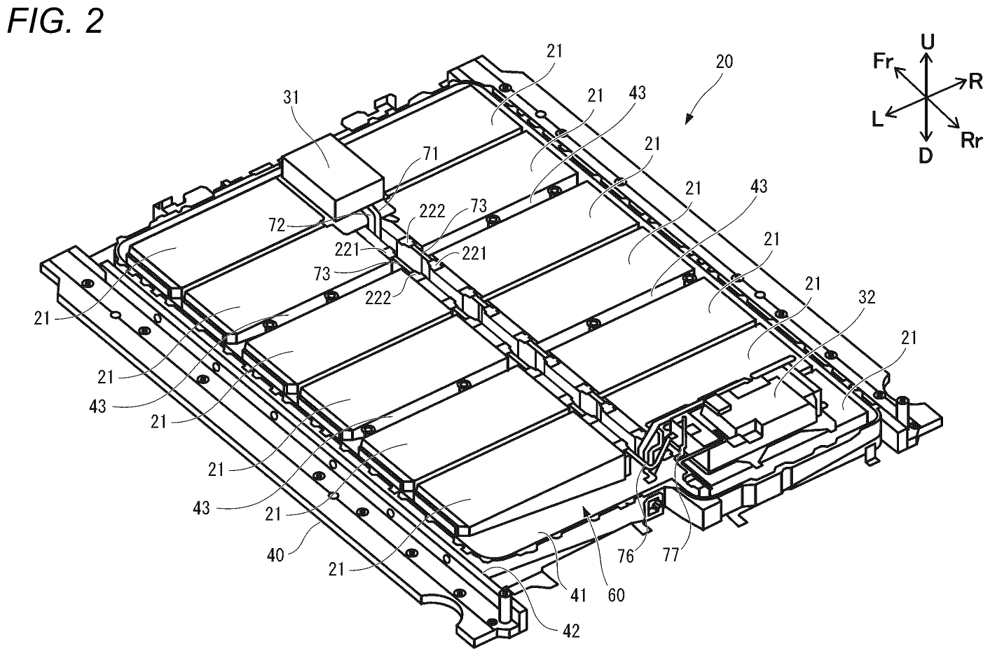

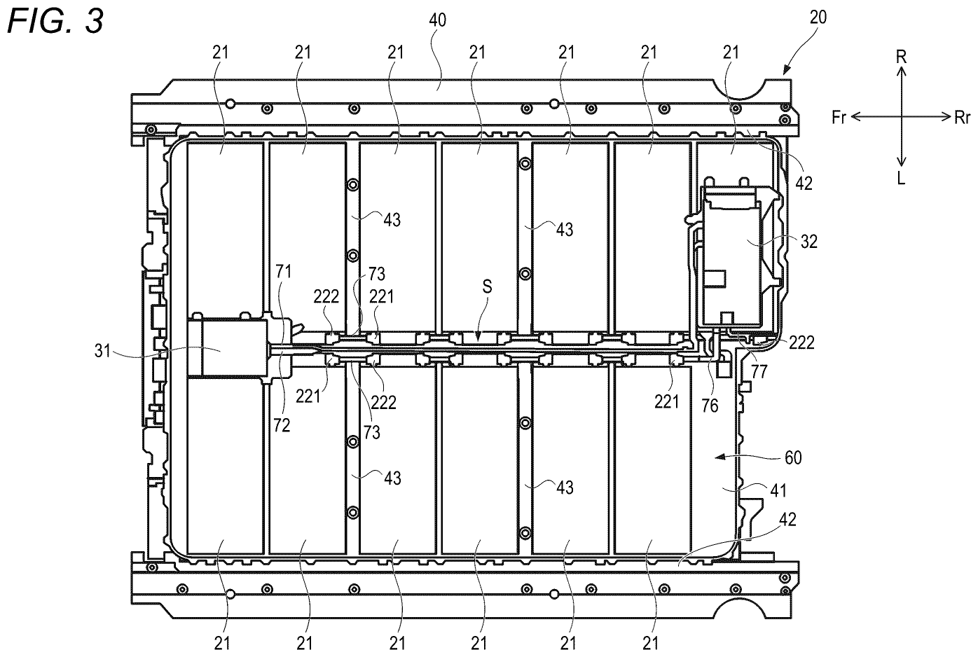

As shown in FIGS. 2 and 3, the battery pack 20 includes the plurality of battery modules 21, a first junction board 31, and a second junction board 32, which are accommodated in the internal space 60.

Each battery module 21 has a substantially rectangular parallelepiped shape. In each battery module 21, a plurality of battery cells are stacked. The plurality of battery cells in each battery module 21 are electrically connected by a bus bar plate (not shown) or the like. Each battery module 21 is an example of a “cell stack” in the present invention. A plus terminal 221 and a minus terminal 222, which are input and output terminals, are provided at an upper portion of each battery module 21. In the present embodiment, the plus terminal 221 and the minus terminal 222 are aligned in a short-side direction at the upper portion of each battery module 21 on one end on one side in a longitudinal direction when viewed in the upper-lower direction.

Each battery module 21 is disposed in the internal space 60 such that the longitudinal direction extends in a vehicle width direction and the short-side direction extends in the front-rear direction when viewed in the upper-lower direction. Further, each battery module 21 is disposed in the internal space 60 such that a side where the plus terminal 221 and the minus terminal 222 are provided in the longitudinal direction is a center side in the vehicle width direction.

The battery modules 21 are aligned in the front-rear direction in two rows in the left-right direction, and a total of thirteen battery modules 21 are disposed. Specifically, seven battery modules 21 are aligned in the front-rear direction in a right row, and six battery modules 21 are aligned in the front-rear direction in a left row. Each cross member 43 described above is provided between battery modules 21 adjacent in the front-rear direction.

The first junction board 31 is accommodated in the internal space 60 and is disposed in the vicinity of a front end of the battery pack 20. More specifically, in the internal space 60, the first junction board 31 is disposed above the battery modules 21 aligned foremost in the left-right direction to straddle the battery modules 21 aligned foremost in the left-right direction.

The second junction board 32 is accommodated in the internal space 60 and is disposed in the vicinity of a rear end of the battery pack 20. More specifically, in the internal space 60, the second junction board 32 is disposed above the battery module 21 disposed rearmost in the right row.

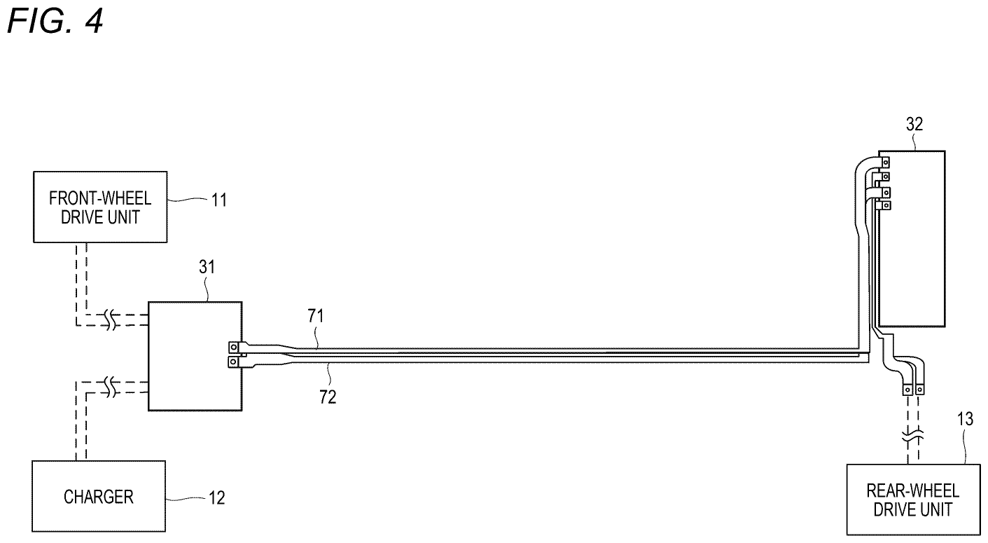

As shown in FIGS. 3 and 4, bus bars 71 and 72, which are high-voltage electric power lines connecting the first junction board 31 to the second junction board 32, are routed in the internal space 60. The bus bars 71 and 72 are high-voltage electric power lines through which electric power stored in the battery module 21 and supplied to a vehicle drive motor to be described later flows, with one serving as a plus side and the other serving as a minus side.

The first junction board 31 is electrically connected to a front-wheel drive unit 11 including a motor that drives front wheels and a charger 12 that receives electric power supplied from an external charger. The first junction board 31 is also electrically connected to an auxiliary device (an air conditioner heater or an air conditioner compressor), which is not shown. The first junction board 31 includes an electric power input and output circuit for the front-wheel drive unit 11, an electric power input and output circuit for the charger 12, and an electric power input and output circuit for the auxiliary device.

In addition to the first junction board 31, the second junction board 32 is electrically connected to the battery module 21 and a rear-wheel drive unit 13 including a motor that drives rear wheels. The second junction board 32 includes an electric power input and output circuit for the battery module 21 and an electric power input and output circuit for the rear-wheel drive unit 13. The second junction board 32 also includes a circuit breaker that is an electrical component for interrupting power supply to the battery pack 20 at the time of an abnormality.

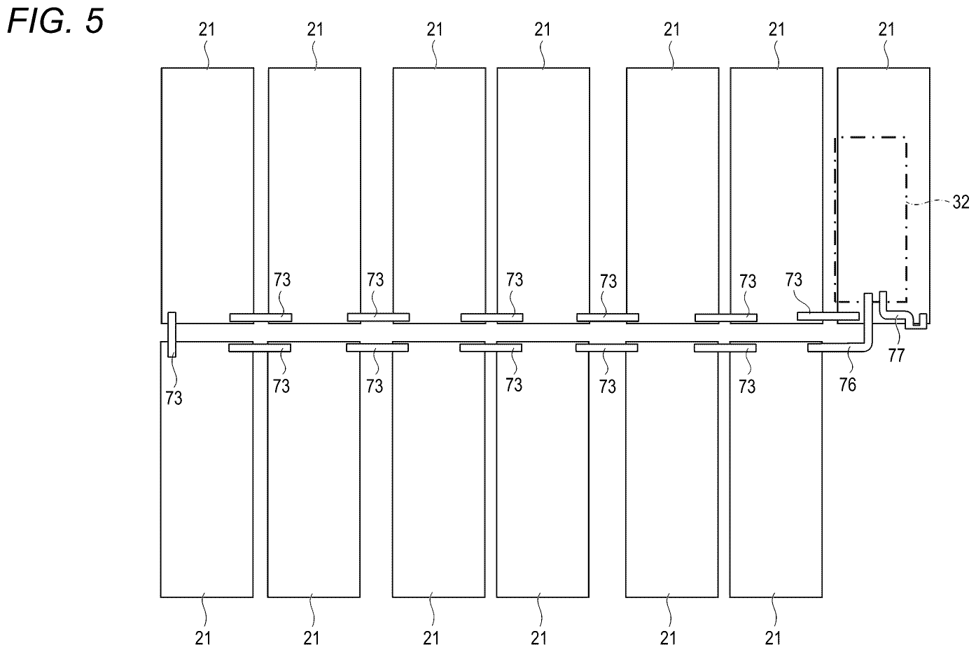

As shown in FIGS. 3 and 5, the battery pack 20 includes a plurality of bus bars 73 that electrically connect the minus terminals 222 and the plus terminals 221 of the adjacent battery modules 21. In the present embodiment, the thirteen battery modules 21 are connected in series via the plurality of bus bars 73.

The battery pack 20 further includes, in the internal space 60, a plus-side bus bar 76 that electrically connects the second junction board 32 to the plus terminal 221 of the battery module 21 disposed rearmost in the left row, and a minus-side bus bar 77 that electrically connects the second junction board 32 to the minus terminal 222 of the battery module 21 disposed rearmost in the right row.

In this way, the second junction board 32 is electrically connected to the thirteen battery modules 21 connected in series.

Next, details of the bus bars 71 and 72 will be described with reference to FIGS. 2 to 4, 6, and 7.

The bus bars 71 and 72 are elongated and extend in the front-rear direction in the internal space 60 of the battery pack 20. Specifically, the bus bars 71 and 72 extend in a space S between battery modules 21 adjacent in the left-right direction and electrically connect the first junction board 31 and the second junction board 32. In the space S, the bus bars 71 and 72 are routed at positions lower than an upper surface of each battery module 21.

Since the first junction board 31 and the second junction board 32 are electrically connected using the bus bars 71 and 72, it is possible to achieve space saving as compared to using a cable for connection. Since the bus bars 71 and 72 are disposed in the space S between the adjacent battery modules 21 and extend from a front end to a rear end of the lower case 40, a space in the lower case 40 can be effectively used.

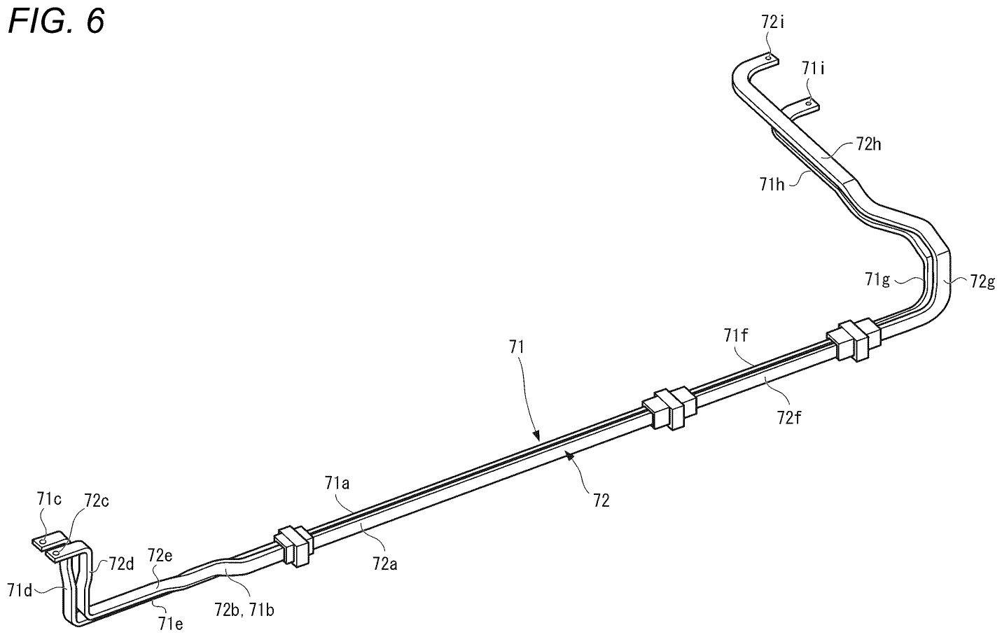

As shown in FIGS. 3 and 6, a part of the bus bars 71 and 72 is disposed such that wide surfaces 71a and 72a respectively face side surfaces (outer surfaces) of the adjacent battery modules 21 in the space S between the adjacent battery modules 21. In this way, the space S between the adjacent battery modules 21 can be narrowed.

The bus bars 71 and 72 also have twisted portions 71b and 72b twisted along a direction of extension in the space S between the adjacent battery modules 21. In the present embodiment, the twisted portions 71b and 72b are twisted by 90 degrees along the direction of extension. The twisted portions 71b and 72b allow the wide surfaces 71a and 72a of the bus bars 71 and 72 to respectively face the side surfaces of the adjacent battery modules 21.

As shown in FIGS. 3 and 7, a part of the bus bars 71 and 72 extends along the rib 44 provided at the bottom plate portion 41 of the lower case 40. In this way, when a load due to a collision in the front-rear direction is input to the battery pack 20, input to the bus bars 71 and 72 can be reduced.

The bus bars 71 and 72 extend in the front-rear direction through a gap formed between the cross member 43 and the reinforcing plate 45 in the space S between the adjacent battery modules 21. Accordingly, it is possible to prevent the bus bars 71 and 72 from protruding upward and preventing the battery pack 20 from becoming large in the upper-lower direction.

The bus bars 71 and 72 as described above are formed in a shape as shown in FIG. 6, for example. The bus bars 71 and 72 include first fastening portions 71c and 72c fastened to terminals of the first junction board 31, first upper-lower extending portions 71d and 72d extending downward from the first fastening portions 71c and 72c, first front-rear extending portions 71e and 72e extending rearward from lower ends of the first upper-lower extending portions 71d and 72d, the twisted portions 71b and 72b formed at rear ends of the first front-rear extending portions 71e and 72e, second front-rear extending portions 71f and 72f extending rearward from the twisted portions 71b and 72b, second upper-lower extending portions 71g and 72g extending upward from rear ends of the second front-rear extending portions 71f and 72f, left-right extending portions 71h and 72h extending rightward from upper ends of the second upper-lower extending portions 71g and 72g, and second fastening portions 71i and 72i provided at right ends of the left-right extending portions 71h and 72h and fastened to terminals of the second junction board 32.

In such bus bars 71 and 72, the first front-rear extending portions 71e and 72e, the twisted portions 71b and 72b, and the second front-rear extending portions 71f and 72f are disposed in the space S, and the wide surfaces 71a and 72a of the second front-rear extending portions 71f and 72f respectively face the side surfaces of the adjacent battery modules 21.

It is preferable that the bus bars 71 and 72 do not include any welded portion. Specifically, the bus bars 71 and 72 are preferably formed of a single member. Since there is no welded portion, it is possible to prevent a decrease in electrical conductivity due to welding, and to form the bus bars 71 and 72 with high strength.

The bus bars 71 and 72 can be made of aluminum, copper, or an alloy thereof. In particular, when the bus bars 71 and 72 are made of aluminum, a weight of the battery pack 20 can be reduced.

Since aluminum has relatively low electrical conductivity as compared to copper, when the bus bars 71 and 72 are made of aluminum, a structure for ensuring a sufficient allowable current allowed for the bus bars 71 and 72 is required. Specifically, the aluminum bus bars 71 and 72 need to have a larger cross-sectional area (specifically, a width and a thickness of the bus bars) than copper bus bars.

Therefore, it is desirable to design the cross-sectional area of the bus bars 71 and 72 made of aluminum based on a current value allowed when the bus bars are assumed to be made of copper. Specifically, the cross-sectional area of the aluminum bus bars 71 and 72 is set such that a current value allowed for the aluminum bus bars 71 and 72 is substantially equal to (or exceeds) a current value allowed for the copper bus bars. In this way, it is possible to design the cross-sectional area of the bus bars 71 and 72 such that the aluminum bus bars 71 and 72 can carry the current value allowed for the copper bus bars.

As described above, in an electrical path from the plurality of battery modules 21 (upstream) to the front-wheel drive unit 11 (downstream), the bus bars 71 and 72 are provided downstream of the second junction board 32 including the circuit breaker. Thus, even when a thermal runaway occurs in the plurality of battery modules 21 and the bus bars 71 and 72 are affected by heat, safety of the electrical path is ensured by operating the circuit breaker. Therefore, the bus bars 71 and 72 may be made of aluminum having lower heat resistance than copper.

Although the embodiment of the present invention has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiments may be freely combined without departing from the gist of the invention.

For example, in the above embodiment, the bus bars 71 and 72 are disposed in the space S between the adjacent battery modules 21, and may alternatively be disposed in a space between the battery modules 21 and the lower case 40 (side wall portion 42).

In the above embodiment, the bus bars 71 and 72 electrically connect the first junction board 31 disposed in the vicinity of the front end of the battery pack 20 and the second junction board 32 disposed in the vicinity of the rear end of the battery pack 20, and may alternatively be configured to connect an electrical device (for example, the battery module 21) other than the junction boards.

In the above embodiment, the battery module 21 is shown as the example of the “cell stack”, but the “cell stack” is not limited thereto, and may be a plurality of battery cells stacked without being modularized.

In the above embodiment, the plurality of battery modules 21 are aligned in the front-rear direction in the two rows in the left-right direction in the internal space 60 of the battery pack 20, but the alignment can be set as desired. In addition, the number of the battery modules 21 accommodated in the internal space 60 is not limited to thirteen and can be set as desired.

In this specification, at least the following matters are described. Although corresponding constituent elements or the like in the embodiment described above are shown in parentheses, the present invention is not limited thereto.
(1) A battery pack (battery pack 20) including:
a plurality of electrical devices (battery module 21, first junction board 31, second junction board 32) including a cell stack (battery module 21) in which a plurality of battery cells are stacked and a junction board (first junction board 31, second junction board 32) electrically connected to the cell stack; and
a case (lower case 40) that accommodates the plurality of electrical devices, in which
the plurality of electrical devices include
   a first electrical device (first junction board 31) and a second electrical device (second junction board 32) that are respectively disposed at one end and another end of the case in a predetermined first direction among horizontal directions and are electrically connected to each other via a bus bar (bus bar 71, 72), and
   a plurality of third electrical devices (battery module 21) disposed between the first electrical device and the second electrical device in the first direction, and
the bus bar extends in a space (space S) between the third electrical devices adjacent to each other or a space between the third electrical devices and the case, and connects the first electrical device and the second electrical device.

According to (1), since the first electrical device and the second electrical device are electrically connected to each other using the bus bar, it is possible to achieve space saving as compared to using a cable for connection. In addition, since the bus bar is disposed in the space between the adjacent third electrical devices or the space between the third electrical devices and the case and extends from the one end to the other end of the case, a space in the case can be effectively used.
(2) The battery pack according to (1), in which
at least a part of the bus bar
   is disposed such that wide surfaces (surface 71a, 72a) of the bus bar respectively face outer surfaces of the adjacent third electrical devices in the space between the adjacent third electrical devices, or
   is disposed such that the wide surfaces (surface 71a, 72a) respectively face outer surfaces of the third electrical devices and the case in the space between the third electrical devices and the case.

According to (2), the space between the adjacent third electrical devices can be narrowed.
(3) The battery pack according to (2), in which
the bus bar has a twisted portion (twisted portion 71b, 72b) twisted along a direction of extension in the space between the adjacent third electrical devices or the space between the third electrical devices and the case.

According to (3), since the bus bar has the twisted portion, the wide surfaces of the bus bar can respectively face the adjacent third electrical devices or respectively face the third electrical devices and the case.
(4) The battery pack according to any one of (1) to (3), in which
each of the first electrical device and the second electrical device is the junction board that electrically connects the cell stack and a drive motor (front-wheel drive unit 11, rear-wheel drive unit 13) mounted on a vehicle, and
the bus bar is a high-voltage electric power line through which electric power stored in the cell stack and supplied to the drive motor flows.

According to (4), by forming the high-voltage electric power line by the bus bar, it is possible to achieve space saving of the battery pack as compared to a case where the high-voltage electric power line is formed by a cable.
(5) The battery pack according to any one of (1) to (4), in which
the third electrical devices each include a plurality of the cell stacks disposed in a second direction orthogonal to the first direction among the horizontal directions, and
the bus bar extends in a space between the cell stacks adjacent to each other in the second direction and connects the first electrical device and the second electrical device.

According to (5), the space between the adjacent cell stacks can be effectively used as a space for routing the bus bar.
(6) The battery pack according to any one of (1) to (5), in which
a rib (rib 44) extending along the first direction is provided at a bottom plate portion (bottom plate portion 41) of the case, and
at least a part of the bus bar extends along the rib.

According to (6), since at least a part of the bus bar extends along the rib, it is possible to reduce input to the bus bar when a load in the first direction is input to the battery pack.
(7) The battery pack according to any one of (1) to (6), in which
the bus bar does not include a welded portion.

According to (7), it is possible to prevent a decrease in electrical conductivity due to welding.
(8) The battery pack according to any one of (1) to (7), in which the bus bar is made of aluminum, copper, or an alloy thereof.

According to (8), the bus bar can be made of aluminum, copper, or an alloy thereof.
(9) The battery pack according to (8), in which
the bus bar is made of aluminum.

According to (9), a weight of the battery pack can be reduced.
(10) The battery pack according to (9), in which
a cross-sectional area of the bus bar is designed based on a current value allowed when the bus bar is assumed to be made of copper.

According to (10), it is possible to design the cross-sectional area of the bus bar such that the aluminum bus bar can carry the current value allowed for the copper bus bar.

### REFERENCE SIGNS LIST

11 front-wheel drive unit (drive motor)
13 rear-wheel drive unit (drive motor)
20 battery pack
21 battery module (cell stack, third electrical device)
31 first junction board (first electrical device)
32 second junction board (second electrical device)
40 lower case (case)
41 bottom plate portion
44 rib
71, 72 bus bar
71a, 72a wide surface
71b, 72b twisted portion

What is claimed is:

1. A battery pack comprising:
a plurality of electrical devices including a cell stack in which a plurality of battery cells are stacked and a junction board electrically connected to the cell stack; and
a case that accommodates the plurality of electrical devices, wherein
the plurality of electrical devices include
a first electrical device and a second electrical device that are respectively disposed at one end and another end of the case in a predetermined first direction among horizontal directions and are electrically connected to each other via a bus bar, and
a plurality of third electrical devices disposed between the first electrical device and the second electrical device in the first direction, and
the bus bar extends in a space between adjacent ones of the plurality of third electrical devices or a space between the plurality of third electrical devices and the case, to connect the first electrical device and the second electrical device.

2. The battery pack according to claim 1, wherein
at least a part of the bus bar
is disposed in the space between the adjacent ones of the plurality of third electrical devices such that wide surfaces of the bus bar, which are wider than other surfaces of the bus bar, respectively face outer surfaces of the adjacent ones of the plurality of third electrical devices, or
is disposed in the space between the plurality of third electrical devices and the case such that the wide surfaces of the bus bar respectively face outer surfaces of the third electrical devices and the case.

3. The battery pack according to claim 2, wherein
the bus bar has a twisted portion twisted along a direction, to which the bus bar extends, in the space between the adjacent ones of the plurality of third electrical devices or the space between the plurality of third electrical devices and the case.

4. The battery pack according to claim 1, wherein
each of the first electrical device and the second electrical device is the junction board that electrically connects the cell stack and a drive motor mounted on a vehicle, and
the bus bar is a high-voltage electric power line through which electric power stored in the cell stack and supplied to the drive motor flows.

5. The battery pack according to claim 2, wherein
each of the first electrical device and the second electrical device is the junction board that electrically connects the cell stack and a drive motor mounted on a vehicle, and
the bus bar is a high-voltage electric power line through which electric power stored in the cell stack and supplied to the drive motor flows.

6. The battery pack according to claim 3, wherein
each of the first electrical device and the second electrical device is the junction board that electrically connects the cell stack and a drive motor mounted on a vehicle, and
the bus bar is a high-voltage electric power line through which electric power stored in the cell stack and supplied to the drive motor flows.

7. The battery pack according to claim 1, wherein
the plurality of third electrical devices each include a plurality of the cell stacks disposed in a second direction orthogonal to the first direction among the horizontal directions, and
the bus bar extends in a space between the cell stacks adjacent to each other in the second direction, to connect the first electrical device and the second electrical device.

8. The battery pack according to claim 2, wherein
the plurality of third electrical devices each include a plurality of the cell stacks disposed in a second direction orthogonal to the first direction among the horizontal directions, and
the bus bar extends in a space between the cell stacks adjacent to each other in the second direction, to connect the first electrical device and the second electrical device.

9. The battery pack according to claim 3, wherein
the plurality of third electrical devices each include a plurality of the cell stacks disposed in a second direction orthogonal to the first direction among the horizontal directions, and
the bus bar extends in a space between the cell stacks adjacent to each other in the second direction, to connect the first electrical device and the second electrical device.

10. The battery pack according to claim 1, wherein
a rib extending along the first direction is provided at a bottom portion of the case, and
at least a part of the bus bar extends along the rib.

11. The battery pack according to claim 2, wherein
a rib extending along the first direction is provided at a bottom portion of the case, and
at least a part of the bus bar extends along the rib.

12. The battery pack according to claim 3, wherein
a rib extending along the first direction is provided at a bottom portion of the case, and
at least a part of the bus bar extends along the rib.

13. The battery pack according to claim 1, wherein
the bus bar does not include a welded portion.

14. The battery pack according to claim 2, wherein
the bus bar does not include a welded portion.

15. The battery pack according to claim 3, wherein
the bus bar does not include a welded portion.

16. The battery pack according to claim 1, wherein
the bus bar comprises aluminum, copper, or an alloy thereof.

17. The battery pack according to claim 2, wherein
the bus bar comprises aluminum, copper, or an alloy thereof.

18. The battery pack according to claim 3, wherein
the bus bar comprises aluminum, copper, or an alloy thereof.

19. The battery pack according to claim 16, wherein
the bus bar comprises aluminum.

20. The battery pack according to claim 19, wherein
a cross-sectional area of the bus bar is designed based on a current value allowed in a case where the bus bar is assumed to be made of copper.
